(19) United States
(12) Patent Application Publication
(10) Pub. No.: US 2008/0004937 A1
(43) Pub. Date: Jan. 3, 2008

(54) USER ACTIVITY RATING

(75) Inventors: Richard Tao-Hwa Chow, Sunnyvale, CA (US); Ankur Subhash Jain, Mountain View, CA (US); Boris Klots, Belmont, CA (US)

Correspondence Address: BEYER WEAVER LLP, P.O. BOX 70250, OAKLAND, CA, 94612-0250, US

(73) Assignee: YAHOO! INC., Sunnyvale, CA (US)

(21) Appl. No.: 11/424,334

(22) Filed: Jun. 15, 2006

(51) Int. Cl. G06F 17/30

(52) U.S. Cl. 705/10

(57) ABSTRACT

An indication is generated of desirability of user's activity relative to a website that includes a plurality of web pages. Indications of the user's activity with respect to the plurality of web pages are processed. At least a portion of the indications are of user's activity with respect to the website other than a conversion activity with respect to the website. Based on the processed indications, generating an overall indication of desirability of the user's activity with respect to the web site. Theses steps may be repeated for a plurality of users. Each user's activity may be categorized (not based on the determined overall indication of desirability), and a measure of the quality of the category determination may be determined using the determined overall indications of desirability. In one example, the categorization is a result of applying click fraud detection filter processing, and the determined overall indications of desirability can be used to determine a measure of the quality of the click fraud detection filter processing.

### BACKGROUND

Conversions are desirable events on an advertiser website. That is, search query keywords may result in the search engine causing display of particular advertisements, based on the search query keywords. In another example, a displayed web page may be processed and, when particular keywords appear on the web page, advertising is caused to be displayed based on the appearance of the particular keywords. To measure the effectiveness of the advertising, some advertisers use various conversion-tracking software (for example, Conversion Counter by Yahoo! or Conversion Tracking by Google) to monitor conversions and generate conversion flags, indicating a conversion, based on the monitoring. Business decisions such as bid price on particular keywords) are conventionally based on metrics such as “conversion rate” or “cost per conversion.”

### SUMMARY

In accordance with an aspect, an indication is generated of desirability of user's activity relative to a website that includes a plurality of web pages. Indications of the user's activity with respect to the plurality of web pages are processed. At least a portion of the indications are of user's activity with respect to the website other than a conversion activity with respect to the website. Based on the processed indications, generating an overall indication of desirability of the user's activity with respect to the web site.

Theses steps may be repeated for a plurality of users. Each user's activity may be categorized (not based on the determined overall indication of desirability), and the quality of the category determination may be determined using the determined overall indications of desirability. In one example, the categorization is a result of applying click fraud detection filter processing, and the determined overall indications of desirability can be used to determine a measure of the quality of the click fraud detection filter processing.

### BRIEF DESCRIPTION OF THE DRAWINGS

FIG. 1 is a flowchart broadly illustrating a process to determine and process an overall indication of the desirability of a user's activity (UAR) relative to a web site.

FIG. 2 illustrates values being ascribed to each of at least some pages of a web site based on a perceived probability that a conversion will result from a user who reaches that page.

FIG. 3 is a flowchart that broadly illustrates an aspect in which a UAR is generated for a web page relative to each of multiple users, and the UARs are then considered in some manner in the aggregate.

FIG. 4 illustrates a Venn diagram in which clicks of a universe of clicks are categorized into a category of filtered (nominally fraudulent) clicks and a category of unfiltered (nominally non-fraudulent) clicks.

FIG. 5 is a flowchart illustrating a method to use UARs to determine quality of a particular categorization of user activity, where the particular categorization is not based on UARs.

FIG. 6 is a graph illustrating an example of analyzing UARs over time, where a spike of low UAR values may indicate undesirable activity.

### DETAILED DESCRIPTION

Conversions are essentially binary activities and, thus, metrics derived based on observing conversion activities typically do not give complete information about the effectiveness of advertising. For example, metrics derived based on observing conversion activities do not provide information about brand awareness.

Recent web analytics tools provide for observation of data regarding activities of users, other than conversion activities of users relative to a website. These tools provide information about the path of a user among the pages of a website and a perceived value for each conversion.

In accordance with an aspect, a method is provided to observe activities by a user relative to a website (typically, an advertiser's website) and to generate an aggregated indication of the desirability of the user's actions relative to the website. The aggregated indication is referred to herein as a User Activity Rating (UAR). Thus, for example, the UAR is determined in consideration of activity beyond just conversion activity (and may not even consider conversion activity). It may be considered that business decisions based on the UAR are more informed business decisions than business decisions based on a metric derived solely from conversion activity.

User activity with respect to a website, beyond merely conversion, can be complex behavior to evaluate. Encapsulating a measurement of user activity into an easy to evaluate indication eases the process of evaluating user activity and of making and acting upon decisions based on an evaluation of user activity.

The UAR is thought to be a very good measure of the quality of a click or other user action that causes a website to be displayed to that user. UAR determination may depend on instrumentation of the web site to gather data of user activity (unless other means are available to observe user activity with respect to the web site). Thus, data useable to determine UAR may not be available for many web sites. However, the instrumentation and data is provided by many web analytics solution such as available, for example, from Yahoo! (YSO Web Analytics).

Conversion flags, discussed above, only have two states—for example, “0” indicates not converting and “1” indicates converting. In accordance with an aspect, a UAR for a user, for a web site, is determined based on a continuum of activity data, such as a sequence of URLs visited by a user (including, for example, an amount of time spent viewing a page or pages associated with each URL) and/or other measurable activity with respect to the web site, perhaps including but not solely based on occurrence of a conversion.

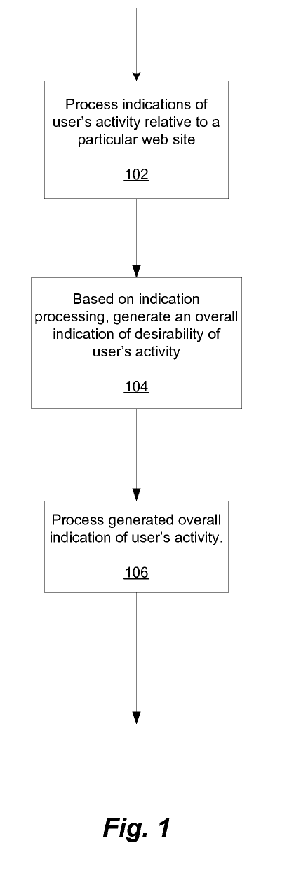

FIG. 1 is a flowchart broadly illustrating a process in accordance with this method. Referring to FIG. 1, at step 102, indicates of a user's activity, relative to a particular web site, are processed. At step 104, based on the processing of the indications, an overall indication of the desirability of the user's activity (UAR) is generated. At step 106, the generated UAR is processed. Some examples of the processing of the UAR are discussed below.

In accordance with one example, a value is ascribed to each time unit (e.g., five minute increments) spent on the advertiser site and a value is ascribed to particular events of the user relative to the web site. For instance, each minute the user spends on the site may be ascribed a value of 15. The event of landing on the site may be ascribed a value of 50, and each $0.10 of conversion value is ascribed a value of 1. All the values associated with a particular visit are combined (e.g., in a simple example, summed). The UAR may be limited to a threshold (in one example, 1000). Using these example ascribed values, UARs shown in Table 1 may result:

TABLE 1
UAR Examples

| Activities | UAR |
|---|---|
| Clicks through to website (50), no further activity | 50 |
| Clicks through to website (50), explores website for 5 minutes in | 125 |
| series of clicks (75) | |
| Clicks through to website (50), explores website for 20 minutes | 470 |
| (300), two conversions valued at $5 (50) and $7 (70). | |
| Clicks through to website (50), explores website for 30 minutes | 600 |
| (450), purchases $10 item on website (100) | |
| Clicks through to website (50), explores website for 45 minutes | 1000 |
| (675), purchases $500 worth of items on website (5000) [limited to | |
| threshold] | |

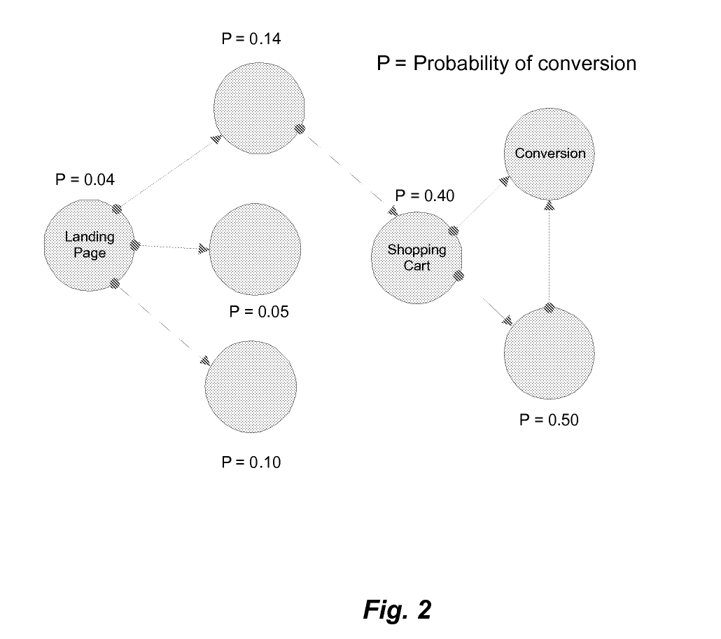

In accordance with an aspect, illustrated schematically in FIG. 2, a value is ascribed to each of at least some pages of a web site (the pages of the web site are represented by the circles in FIG. 2) based on a perceived probability (represented by the “P=” indications, in FIG. 2) that a conversion will result from a user who reaches that page. For example, probabilities may be calculated based on the data collected from multiple user visits. In one example, with regard to the values ascribed based on perceived probabilities, the actual UAR for a web site (or, at least, the contribution to the UAR based on the perceived probabilities), for a particular user, is the highest UAR associated with a visited page of that web site by the particular user. In the FIG. 1 example, the activity of a user reaching the “Shopping Cart” web page would have a UAR contribution of 0.40. In some examples, the probability associated with a web page is a value between 0 and 1, which is then multiplied by an average conversion value associated with the web site.

Having discussed some examples of determining UAR for a web site, relative to a particular user, we now discuss some applications of the UAR. In one example, the cost to an advertiser of a particular “click” (i.e., activation of a link to an advertiser web page, from a display advertisement) is based on a UAR associated with that click. As a variation, the cost to an advertiser of a collection of clicks may be based on an amalgamation of the UARs associated with the clicks.

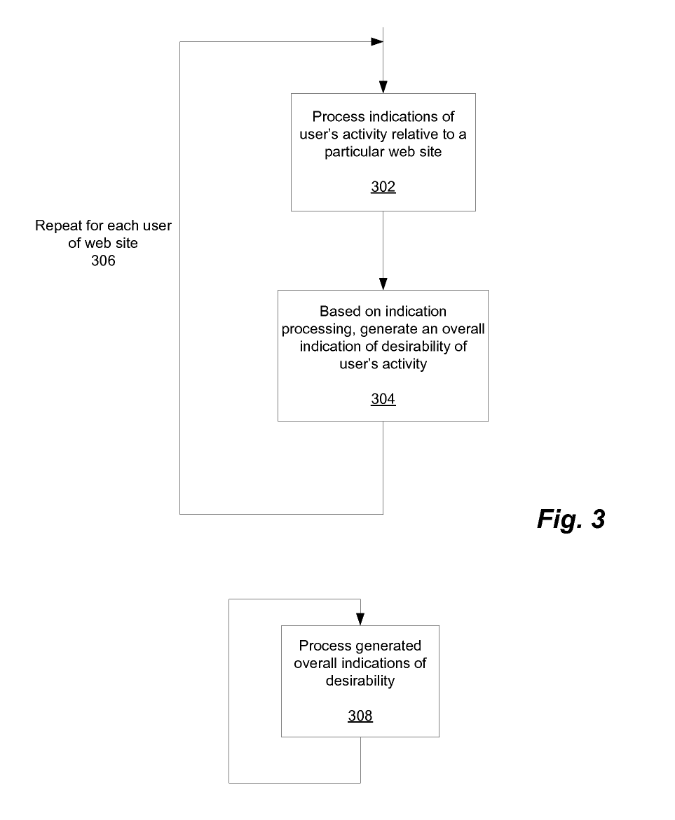

In accordance with another aspect, a UAR is generated for a web page relative to each of multiple users, and the UARs are then considered in some manner in the aggregate. FIG. 3 is a flowchart that broadly illustrates this aspect. Steps 302 and 304 in the FIG. 3 flowchart are similar to steps 102 and 104 in the FIG. 1 flowchart. However, steps 302 and 304 are shown (indicated by arrow 306) as being repeated for multiple users. Meanwhile, at step 308, the UARs for the multiple users are processed.

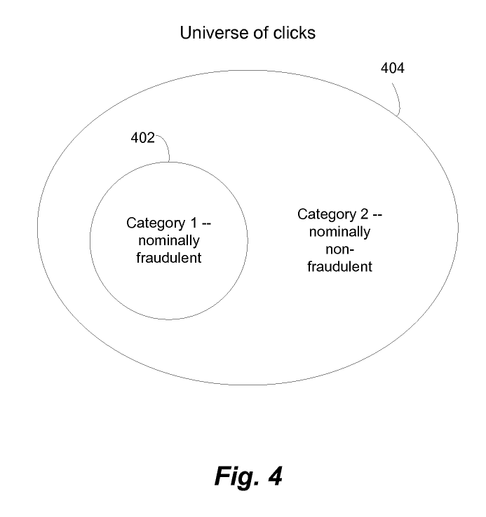

In one particular example of this aspect broadly illustrated in FIG. 3, the effectiveness of click-through protection filter processing is measured. Click-through protection filter processing includes processing to evaluate the activity of a user after a click on a link in an advertisement to determine whether that click is a “fraudulent” click—one solely or primarily generated to cause the advertiser to be charged for activation of the link. In the Venn diagram illustrated in FIG. 4, a categorization of clicks of a universe of clicks into a category 402 of filtered (nominally fraudulent) clicks and a category 404 of unfiltered (nominally non-fraudulent) clicks is illustrated.)

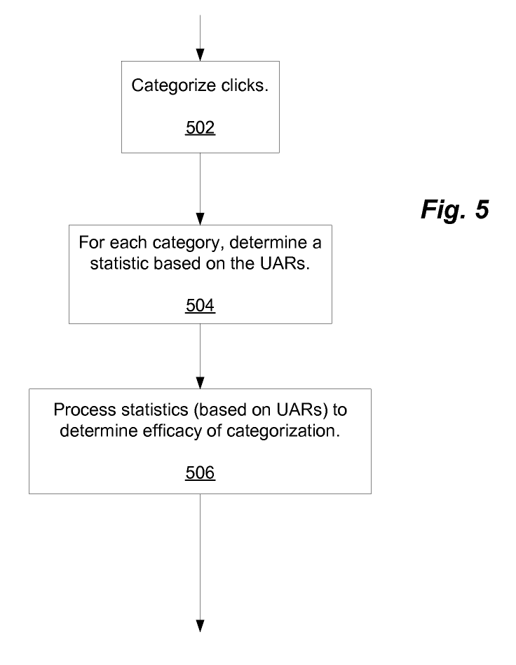

In accordance with a general example, illustrated in the FIG. 5 flowchart, user activity (such as a click on a link in an advertisement) is categorized, not based on UARs corresponding to that activity (step 502). At step 504, a statistic is determined for the categories (a category may be the “universe” of user activity, including all categories), based on the UAR (e.g., the statistic may be an average UAR for each category). At step 506, the determined statistics are processed to determine a measure of the quality of the categorization.

Using the click through protection filter processing example, step 504 of the FIG. 5 processing may include determining an average UAR for the activity corresponding to the nominally fraudulent clicks and an average UAR for the activity corresponding to the universe of clicks (or, for example, for the activity corresponding to the nominally non-fraudulent clicks). Step 506, may include determining a ratio of average UAR for filtered clicks to average UAR for all clicks, to determine the measure of the quality of the click through filter processing, as follows:

$$\frac{Average UAR on filtered set}{Overall average UAR}$$

For a good filter, a filtered set of clicks predominately includes lower quality traffic, and so the average UAR is lower for the filtered set. In accordance with this example, then, small ratios (according to some measure of what is “small”) correspond to good filters.

Another application of UAR is in analysis of web traffic anomalies. Anomalies in web traffic are often evidenced by lower quality. In fact, many advertiser complaints arise because some spike in a characteristic of advertisement activation is noticed, such as a sudden increase in activations resulting from a particular query term or phrase, or a sudden increase in activations coming from outside a normally-expected geographic area. Advertisers are loathe to pay for such activations, since the advertisers suspect that the activations do not result in activity that represents a desired effect.

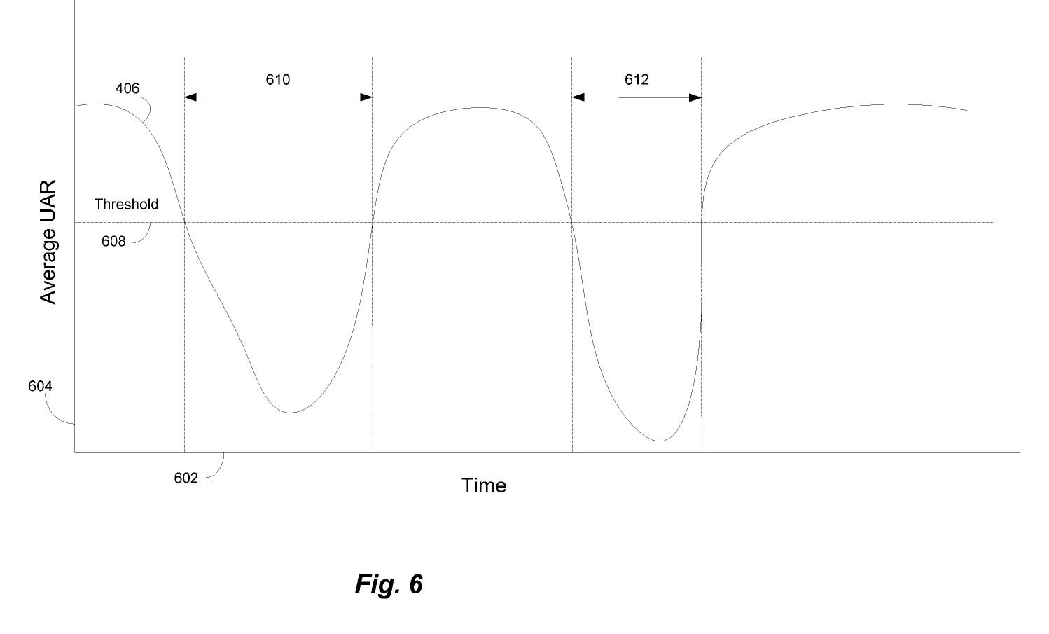

To analyze such web traffic anomalies, the UARs corresponding to activations having the particular characteristic are analyzed. If it is determined that at least some of the clicks in the category have relatively lower corresponding UARs, then this may be an indicator that all clicks during the anomaly may be considered to be of low quality. Another approach is to analyze UARs over time (either individually, on a rolling average, or based on some other relatively localized statistic), where a spike of low UAR values may indicate an attack. FIG. 6 illustrates an example where a rolling average of the UARs is shown as being graphed 406 on the y-axis 604 versus time on the x-axis 602.

A threshold 608 indicates a value for the average UAR below which the activations resulting in those UARs are deemed to be of low quality. Referring to the FIG. 4 example, the time periods 610 and 612 are thus deemed to be time periods that are “anomalous,” such that activations during these time periods 610 and 612 are treated as being of low quality.

By using an aggregated indication of the desirability of the user's actions relative to a website, more information about the effectiveness of advertising may be gleaned than from, for example, information of conversions alone. For example, business decisions such as bid price on particular keywords may be made in a more informed manner. In addition, the aggregated indications may be employed to provide a measure of how well a categorization process, of user's actions, such as click fraud detection processing, has performed.

What is claimed is:

1. A method of generating an indication of desirability of user's activity relative to a website that includes a plurality of web pages, the method comprising:
a) processing indications of the user's activity with respect to the plurality of web pages, at least a portion of the indications being of user's activity with respect to the website other than a conversion activity with respect to the website; and
b) based on the processed indications, generating an overall indication of desirability of the user's activity with respect to the web site.

2. The method of claim 1, wherein:
step a) includes processing each indication of the user's activity to determine a corresponding indication of probability of the indicated activity resulting in a conversion activity; and
step b) includes processing the determined probability indications to generate the overall indication of desirability of the user's activity with respect to the web site.

3. The method of claim 1, wherein:
step a) includes processing each indication of the user's activity to determine a corresponding indication of desirability of the user's activity; and
step b) includes processing the determined desirability indications to generate the overall indication of desirability of the user's activity with respect to the web site.

4. The method of claim 1, further comprising:
c) evaluating the user's activity based on the generated overall indication of desirability of the user's activity.

5. The method of claim 1, wherein:
the method further comprises repeating steps a) and b) for a plurality of users;
for each of the plurality of users, determining which of a plurality of categories into which to fit that user's activity relative to the web site; and
processing the generated overall indications of desirability of the users' activity relative to the web site to determine a measure of the quality of the category determining step.

6. The method of claim 5, wherein:
the category determining step is a filter for click fraud detection, wherein each user's activity in a first category is determined by the click fraud detection filter to be a result of click fraud and each user's activity in a second category is determined by the click fraud detection filter to not be a result of click fraud.

7. The method of claim 5, wherein:
the step of processing the indications of desirability for the users to compare the first category to the second category includes
determining a first aggregated desirability of the activity of the users whose initiating activity is in the first category; and
determining a second aggregated desirability of the activity of the users whose initiating activity is in the second category; and
the step processing the indications of desirability for the users to compare the first category with the second category includes determining a ratio of the first aggregated desirability to the second aggregated desirability.

8. The method of claim 1, wherein:
the method further comprises repeating steps a) and b) for a plurality of users and determining an overall indication of the desirability of the activity of all the users with respect to the web site, based on the determined overall indications of the desirability of each user's activity with respect to the web site;
an advertisement is provided on web pages, in response to particular keywords, wherein the advertisement includes a link to the web site, wherein the link may be activated to display pages of the web site;
the method further comprises determining a bid amount for activation of a link included in an advertisement to be displayed in response to the particular keywords, based on the determined overall indication of the desirability of the activity of all the users with respect to the web site.

9. The method of claim 1, wherein:
the method further comprises repeating steps a) and b) for a plurality of users and determining an overall indication of the desirability of the activity of all the users with respect to the web site, based on the determined overall indications of the desirability of each user's activity with respect to the web site;
the method further comprises ascribing a value to an activation activity of the users with respect to the web site by processing the determined overall indication of the desirability of the activity of all the users with respect to the web site.

10. The method of claim 9, further comprising:
utilizing the ascribed value in a commercial transaction.

11. A computing device operable to perform the method of claim 1.

12. A computer program product to generate an indication of desirability of user's activity relative to a website that includes a plurality of web pages, comprising at least one computer-readable medium having computer program instructions stored therein which are operable to cause at least one computing device to perform the following steps:
a) process indications of the user's activity with respect to the plurality of web pages, at least a portion of the indications being of user's activity with respect to the website other than a conversion activity with respect to the website; and
b) based on the processed indications, generate an overall indication of desirability of the user's activity with respect to the web site.

13. The computer program product of claim 12, wherein:
step a) includes processing each indication of the user's activity to determine a corresponding indication of probability of the indicated activity resulting in a conversion activity; and
step b) includes processing the determined probability indications to generate the overall indication of desirability of the user's activity with respect to the web site.

14. The computer program product of claim 12, wherein:
step a) includes processing each indication of the user's activity to determine a corresponding indication of desirability of the user's activity; and
step b) includes processing the determined desirability indications to generate the overall indication of desirability of the user's activity with respect to the web site.

15. The computer program product of claim 12, wherein the computer program instructions stored on the computer readable medium are further operable to cause at least one computing device to perform the following step:
c) evaluate the user's activity based on the generated overall indication of desirability of the user's activity.

16. The computer program product of claim 12, wherein the computer program instructions stored on the computer readable medium are further operable to cause at least one computing device to:
repeat steps a) and b) for a plurality of users;
for each of the plurality of users, determine which of a plurality of categories into which to fit that user's activity relative to the web site; and
process the generated overall indications of desirability of the users' activity relative to the web site to determine a measure of the quality of the category determining step.

17. The computer program product of claim 16, wherein:
the category determining step is a filter for click fraud detection, wherein each user's activity in a first category is determined by the click fraud detection filter to be a result of click fraud and each user's activity in a second category is determined by the click fraud detection filter to not be a result of click fraud.

18. The computer program product of claim 17, wherein:
the step to process the indications of desirability for the users to compare the first category to the second category includes
determining a first aggregated desirability of the activity of the users whose initiating activity is in the first category; and
determining a second aggregated desirability of the activity of the users whose initiating activity is in the second category; and
the step to process the indications of desirability for the users to compare the first category with the second category includes determining a ratio of the first aggregated desirability to the second aggregated desirability.

19. The computer program product of claim 12, wherein:
the computer program instructions stored on the computer readable medium are further operable to cause at least one computing device to repeat steps a) and b) for a plurality of users and to determine an overall indication of the desirability of the activity of all the users with respect to the web site, based on the determined overall indications of the desirability of each user's activity with respect to the web site;
an advertisement is provided on web pages, in response to particular keywords, wherein the advertisement includes a link to the web site, wherein the link may be activated to display pages of the web site;
the computer program instructions stored on the computer readable medium are further operable to cause at least one computing device to determine a bid amount for activation of a link included in an advertisement to be displayed in response to the particular keywords, based on the determined overall indication of the desirability of the activity of all the users with respect to the web site.

20. The computer program product of claim 12, wherein:
the computer program instructions stored on the computer readable medium are further operable to cause at least one computing device to:
repeat steps a) and b) for a plurality of users and to determine an overall indication of the desirability of the activity of all the users with respect to the web site, based on the determined overall indications of the desirability of each user's activity with respect to the web site; and
ascribe a value to an activation activity of the users with respect to the web site by processing the determined overall indication of the desirability of the activity of all the users with respect to the web site.

21. The computer program product of claim 20, further comprising:
the computer program instructions stored on the computer readable medium are further operable to cause at least one computing device to utilize the ascribed value in a commercial transaction.
